(19) United States
(12) Patent Application Publication
(10) Pub. No.: US 2007/0085682 A1
(43) Pub. Date: Apr. 19, 2007

(54) Moving object management system and moving object apparatus

(76) Inventors: Nobuo Murofushi, Susono-shi (JP); Kouichi Sano, Ihara-gun (JP); Yasuo Matsumoto, Numazu-shi (JP); Takahiro Shimura, Mishima-shi (JP); Yasuhito Kiji, Mishima-shi (JP)

Correspondence Address: HARNESS, DICKEY & PIERCE, P.L.C., P.O. BOX 828, BLOOMFIELD HILLS, MI, 48303, US

(21) Appl. No.: 11/581,791

(22) Filed: Oct. 16, 2006

(30) Foreign Application Priority Data
Oct. 17, 2005 (JP) 2005-302051

(51) Int. Cl. G08B 13/14; G08B 1/08; G08B 5/22

(52) U.S. Cl. 340/572.1; 340/825.49; 340/539.13

(57) ABSTRACT

A moving object apparatus includes a shopping cart to be moved along an aisle which is provided together with wireless tags arranged near the aisle, an antenna which is attached to the shopping cart and has directivity toward a direction predetermined for communication with the wireless tags, and a transmission and reception units which capture positional identification data held by each of the wireless tags which are accessible by the antenna. The moving object apparatus includes a control panel section which processes a capture result based on antenna position data of the antenna which has been used for capturing the positional identification data.

### CROSS-REFERENCE TO RELATED APPLICATIONS

This application is based upon and claims the benefit of priority from prior Japanese Patent Application No. 2005-302051, filed Oct. 17, 2005, the entire contents of which are incorporated herein by reference.

### BACKGROUND OF THE INVENTION

1. Field of the Invention

The present invention relates to a moving object management system which manages travel of a moving object such as a store shopping cart, a warehouse forklift truck, a book carrier cart in a library, or the like, and to a moving object apparatus used for the system.

2. Description of the Related Art

Conventionally, a moving object management system which manages travel of a shopping cart has been known (refer to, for example, Jpn. Pat. Appln. KOKAI Publication No. 2000-357177). This system uses a plurality of identification tags which are attached to article display racks and hold positional identification data. On the other hand, information recorder with an antenna is provided on a shopping cart. The positional identification data is retrieved from the identification tag by wireless communication when the shopping cart moves along an aisle defined by the article display racks, and is recorded in the information recorder together with a current time stamp. Thus, a traveled route which the shopping cart has moved is confirmable from the recorded contents of the information recorder.

This moving object management system grasps the traveled route of the shopping cart, the location of which varies with time passage. However, the moving object management system does not grasp the orientation of the moving shopping cart. Therefore, when a direction of movement has been reversed, it has been impossible to confirm whether the shopping cart has turned around, or has moved backward.

### BRIEF SUMMARY OF THE INVENTION

An object of the present invention is to provide a moving object apparatus which can reliably grasp the orientation of a moving object during the movement along an aisle.

According to the present invention, there is provided a moving object apparatus comprising: a moving object to be moved along an aisle which is provided together with a plurality of wireless tags arranged near the aisle; an antenna unit which is mounted on the moving object and has directivity toward a direction predetermined for communication with the wireless tags; capturing means for capturing positional identification data held by each of the wireless tags which are accessible by the antenna unit; and processing means for processing a capture result of the capturing means based on antenna position data of the antenna unit which has been used for capturing the positional identification data.

In this moving object apparatus, the capture result of the capturing means is processed based on the antenna position data of the antenna unit which has been used for capturing the positional identification data. When the antenna position data of the antenna unit and the positional identification data of the capture result have been obtained, the orientation of the moving object can be specified in addition to the location of the moving object. Accordingly, it is possible to reliably grasp the orientation of the moving object during the movement along the aisle.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a moving object management system according to a first embodiment of the present invention;

FIG. 2 is a perspective view showing the appearances of an article display rack and a shopping cart shown in FIG. 1;

FIGS. 3A and 3B are diagrams for explaining that wireless tags which are able to communicate with the shopping cart shown in FIG. 2 are changed upon movement of the shopping cart;

FIG. 4 is a diagram showing a display example of a display unit shown in FIG. 2;

FIG. 5 is a diagram showing a positional relationship between the shopping cart and the wireless tags in a moving object management system according to a second embodiment of the present invention;

FIG. 6 is a block diagram showing the configuration of a shopping cart in a moving object management system according to a third embodiment of the present invention; and

FIG. 7 is a block diagram showing the configuration of a shopping cart and a server in a moving object management system according to a fourth embodiment of the present invention.

### DETAILED DESCRIPTION OF THE INVENTION

Hereinafter, a moving object management system according to a first embodiment of the present invention will be described with reference to the accompanying drawings. The moving object management system is installed in a store in order to manage travel of shopping carts, for example.

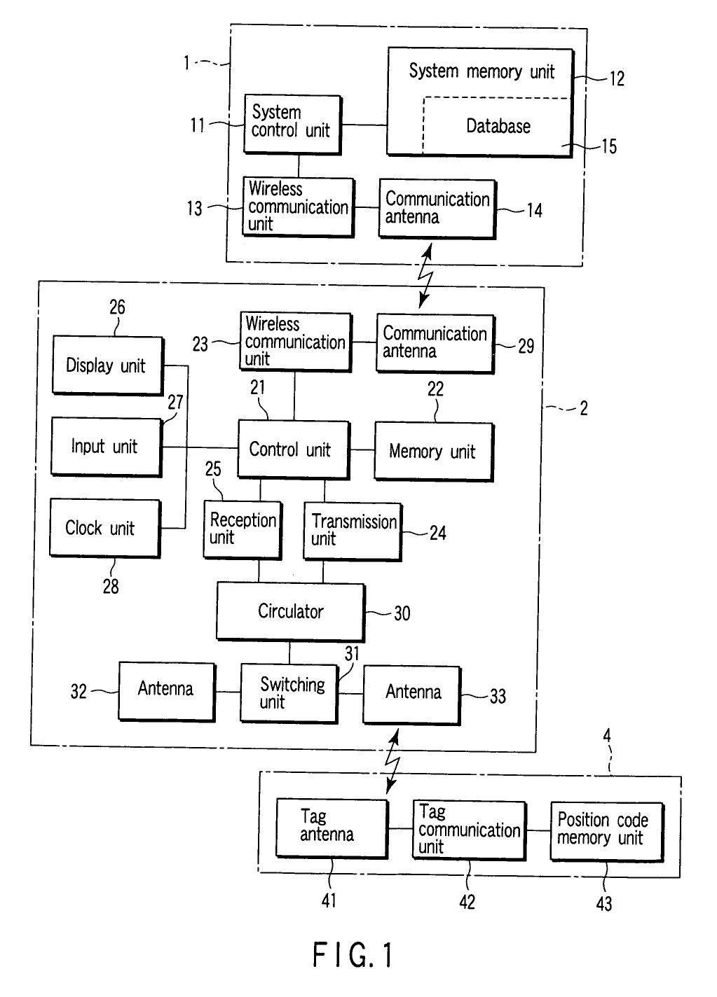

FIG. 1 shows the configuration of the moving object management system. This moving object management system is configured to use a server 1, a shopping cart 2, and wireless tags 4. The shopping cart 2 is a moving object to be moved along an aisle, which is provided together with a plurality of the wireless tags 4. The wireless tags 4 are arranged near the aisle.

The server 1 has a system control unit 11, a system memory unit 12, a wireless communication unit 13, and a communication antenna 14. The system control unit 11 controls the system memory unit 12 connected to the system control unit 11, and the wireless communication unit 13 connected to the system control unit 11. The wireless communication unit 13 is connected to the communication antenna 14. The system memory unit 12 includes a ROM that holds a control program to be executed by the system control unit 11, a RAM that temporarily stores data input to and output from the system control unit 11, and a hard disk drive that holds a database 15 and the like.

The wireless communication unit 13 is provided in the server 1 in order to perform wireless communication under the communication protocol between the server 1 and the shopping cart 2. In the wireless communication unit 13, digital data for transmission from the system control unit 11 is encoded and modulated, and is further converted into a radio signal to be supplied to the communication antenna 14. The communication antenna 14 radiates the radio signal into space. Further, the communication antenna 14 receives the radio signal, and supplies it to the wireless communication unit 13. In the wireless communication unit 13, the received radio signal is converted so as to be at a lower frequency and demodulated, and is decoded into received digital data. This received digital data is supplied to the system control unit 11.

The wireless communication unit 13 and the communication antenna 14 are installed on a ceiling or an upper part of a wall in the store. The system control unit 11 is disposed along with the system memory unit 12 at, for example, a backyard in the store, and is connected to the wireless communication unit 13 away from the system control unit 11 with a cable.

To the shopping cart 2, a control unit 21, a memory unit 22, a wireless communication unit 23, a transmission unit 24, a reception unit 25, a display unit 26, an input unit 27, a clock unit 28, a circulator 30, a switching unit 31, a first antenna 32, and a second antenna 33 are added in order to constitute a moving object apparatus. The control unit 21 includes a CPU, and is connected so as to control the components 22 to 28. The display unit 26 is display means such as a liquid crystal display. The input unit 27 includes a touch panel integrated with the display unit 26 and serving as a keyboard. The clock unit 28 is configured to perform an operation of counting the number of pulses produced at a clock cycle and issuing time-stamp data for use in confirming a current time and time elapse. The memory unit 22 includes a ROM that holds a control program to be executed by the control unit 21, and a RAM that temporarily stores data input to and output from the control unit 21.

The wireless communication unit 23 is provided to the shopping cart 2 in order to perform wireless communication under the communication protocol between the server 1 and the shopping cart 2. In the wireless communication unit 23, digital data for transmission from the control unit 21 is encoded and modulated, and is further converted into a radio signal to be supplied to a communication antenna 29. The communication antenna 29 radiates the radio signal into space. Further, the communication antenna 29 receives the radio signal, and supplies it to the wireless communication unit 23. In the wireless communication unit 23, the received radio signal is converted so as to be at a lower frequency and demodulated, and is decoded into received digital data. This received digital data is supplied to the control unit 21.

The input unit 27 is used for inputting setting data, requests, and the like by an operator, and the display unit 26 is used for displaying location information of the shopping cart 2, information of articles of merchandise, and the like thereon. The displayed contents on the display unit 26 can be changed in accordance with a request input from the server 1 by communication, or a request key-input from the input unit 27. The clock unit 28 outputs a time-stamp data to the control unit 21 under the control of the control unit 21.

The transmission unit 24, the reception unit 25, a circulator 30, a switching unit 31, a first antenna 32, and a second antenna 33 are provided in order to perform wireless communication under the communication protocol between the shopping cart 2 and the wireless tag 4. In the transmission unit 24, digital data for transmission is encoded and modulated, and is converted so as to be at a radio frequency for communication with the wireless tag 4. In the reception unit 25, a signal received from the wireless tag 4 is frequency-converted and demodulated, and is decoded into received digital data to be supplied to the control unit 21.

The transmission unit 24 and the reception unit 25 are connected to the circulator 30. The switching unit 31 is connected to the circulator 30, and the first antenna 32 and the second antenna 33 are connected to the switching unit 31. The circulator 30 outputs the signal input from the transmission unit 24 to the switching unit 31, and outputs the signal input from the switching unit 31 to the reception unit 25.

The switching unit 31 carries out a switching operation for connecting a selected one of the first antenna 32 and the second antenna 33 to the circulator 30. This switching operation is controlled by a control signal from the control unit 21. The first antenna 32 and the second antenna 33 are mounted on the shopping cart 2 and serve as an antenna unit having directivity toward a direction predetermined for communication with the wireless tags 4. Namely, each of the first antenna 32 and the second antenna 33 is a directional antenna having a feature that radiates a strong radio signal toward a specific direction, and has high reception sensitivity to a radio signal coming from the specific direction. For example, flat patch antennas are used as the antennas 32 and 33 in this embodiment. The first antenna 32 and the second antenna 33 are selectively made operative as a result of switching by the switching unit 31.

The transmission unit 24, the reception unit 25, the circulator 30, and the switching unit 31 serve as a capturing unit which captures a position code (positional identification data) held by each wireless tag 4 which is accessible by the antenna unit. Further, the control unit 21, the memory unit 22, the wireless communication unit 23, the communication antenna 29, the display unit 26, the input unit 27, and the clock unit 28 serve as a processing unit which processes a capture result of the capturing unit based on the antenna position data of the antenna unit used to capture the position code within the shopping cart 2.

The wireless tag 4 includes a tag antenna 41, a tag communication unit 42 connected to the tag antenna 41, and a position code memory unit 43 connected to the tag communication unit 42. The wireless tag 4 is a passive type tag which performs backscatter communication with the shopping cart 2 by using power derived from the electromagnetic wave of a received radio signal.

Note that, as the wireless tag, a semi-passive type radio frequency identification (RFID) tag which has a battery for supplying power to internal circuit components and performs backscatter communication with the shopping cart 2, or an active type RFID tag which has a battery for supplying power to internal circuit components and performs the communication in an active manner is also usable. Further, an RFID tag which performs electromagnetic induction type communication, in place of the backscatter communication, is also usable.

The tag antenna 41 and the tag communication unit 42 are provided in order to perform wireless communication under the communication protocol between the shopping cart 2 and the wireless tag 4. The tag antenna 41 receives a radio signal, and radiates a radio signal. The tag communication unit 42 performs demodulation of a received radio signal and transmission responsive to the demodulated signal. The position code memory unit 43 holds a position code indicative of an attachment place where the wireless tag 4 is present. Accordingly, different position codes are assigned to the wireless tags 4.

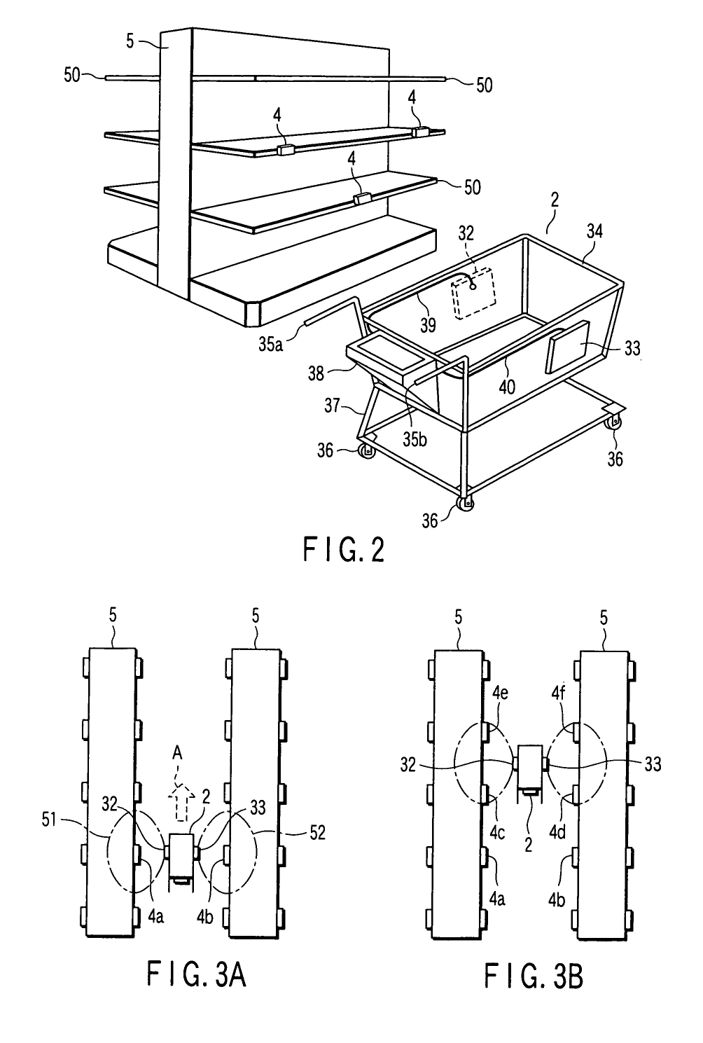

FIG. 2 shows appearances of an article display rack 5 and the shopping cart 2. The wireless tags 4 are attached to the front portions of shelves 50 of the article display rack 5. The position codes of the respective wireless tags 4 are managed by the database 15 of the server 1. The database 15 holds coordinate data which are associated with the position codes held by the wireless tags 4 and represent the position coordinates of these wireless tags 4, which are regarded as the location of the shopping cart 2.

The shopping cart 2 is composed of a basket 34 for receiving articles of merchandise picked up from the article display rack 5 and placed therein, and a cart base 37 supporting the basket 34. The cart base 37 has grips 35a and 35b which are provided at the rear thereof and grasped by hand by a person, and wheels 36 which are fixed to the bottom portion thereof. At the rear of the basket 34, an operation panel section 38 is disposed. The operation panel section 38 contains the control unit 21, the memory unit 22, the wireless communication unit 23, the transmission unit 24, the reception unit 25, the display unit 26, the input unit 27, the clock unit 28, the communication antenna 29, the circulator 30, and the switching unit 31. The first antenna 32 is mounted on the left-side surface of the basket 34, and the second antenna 33 is mounted on the right-side surface of the basket 34. The respective antennas 32 and 33 are connected to the switching unit 31 provided in the operation panel section 38 via coaxial cables 39 and 40, respectively. The shopping cart 2 is a cart which can be moved by being pushed forward by a person standing on the back thereof while holding the grips 35a and 35b by hands.

The wireless tags 4 which are able to communicate with the shopping cart 2 are changed over upon movement of the shopping cart 2 from a place shown in FIG. 3A to a place shown in FIG. 3B. Assuming that the shopping cart 2 is located at the place shown in FIG. 3A while advancing in a direction shown by an arrow A, the first antenna 32 on the left side of the shopping cart 2 is subjected to communication with a tag 4a of the wireless tags 4, and the second antenna 33 on the right side is subjected to communication with a tag 4b of the wireless tags 4.

Each of the wireless tags 4 has directivity for obtaining high reception sensitivity to a radio signal coming from the frontal direction of the attachment place and radiating a strong radio signal toward the frontal direction of the attachment place. Thus, the wireless tag 4a has high sensitivity to a radio signal coming from the right in the drawings, and the wireless tag 4b has high sensitivity to a radio signal coming from the left in the drawings.

Further, the first antenna 32 has directivity for radiating a strong radio signal to the left in the drawings. Accordingly, it is possible to perform wireless communication with the wireless tag 4a opposed in a communication service area 51. The second antenna 33 has directivity for radiating a strong radio signal to the right in the drawings. Accordingly, it is possible to perform wireless communication with the wireless tag 4b opposed in a communication service area 52.

When the shopping cart 2 captures a position code from the wireless tag 4a, first, the control unit 21 outputs a transmission signal to the transmission unit 24 in the shopping cart 2. This transmission signal is radiated as a radio signal via the circulator 30 and the switching unit 31 from the first antenna 32. In the wireless tag 4a, when the radio signal radiated from the first antenna 32 is received at the tag antenna 41, the tag communication unit 42 starts up, and retrieves a position code from the position code memory unit 43, and converts it into a transmission signal to be radiated from the tag antenna 41.

When the first antenna 32 receives the signal from the wireless tag 4a, the received signal is input to the reception unit 25 via the switching unit 31 and the circulator 30. The reception unit 25 outputs the position code obtained from the input signal to the control unit 21. When the control unit 21 receives the position code, the control unit 21 acquires time-stamp data at that point in time from the clock unit 28, and thereafter, stores the position code and the time-stamp data in the memory unit 22, along with associated antenna position data representing that the first antenna 32 has been used to capture the position code. The fact that the first antenna 32 has been used to capture the position code means that the communication has been performed with a wireless tag on the left side of the shopping cart 2.

Thereafter, the control unit 21 sends the position code and the antenna position data to the wireless communication unit 23, so that a signal including the position code and the antenna position data from the wireless communication unit 23 is radiated into space via the communication antenna 29. That is, with the wireless communication unit 23 and the communication antenna 29, the position code and the antenna position data of the directional antenna used for capturing the position code are reported to the server 1 by wireless communication.

In the server 1, when the communication antenna 14 receives the signal radiated from the communication antenna 29, the wireless communication unit 13 outputs the signal as digital data including the position code and the antenna position data, to the system control unit 11.

When the system control unit 11 receives the digital data including the position code and the antenna position data, the system control unit 11 acquires coordinate data corresponding to the received position code, i.e., position coordinates of the wireless tag 4 with reference to the database 15. Further, the system control unit 11 confirms from the coordinate data of the wireless tag 4 on the article display rack 5 that the shopping cart 2 is located on an aisle present on the right side of the article display rack 5. Further, since the position code has been captured by the first antenna 32 on the left side of the shopping cart 2, it is confirmed that the frontal direction of the shopping cart 2, i.e., the orientation of the shopping cart 2 coincides with the direction of the arrow A. In this way, the server 1 obtains the current location and the orientation (frontal direction) of the shopping cart 2.

Thereafter, the system control unit 11 outputs digital data including the coordinate data and the frontal direction of the shopping cart 2, to the wireless communication unit 13. The wireless communication unit 13 transmits the input digital data via the communication antenna 14. In the shopping cart 2, the wireless communication unit 23 receives the digital data via the communication antenna 29. Then, the digital data is supplied from the wireless communication unit 23 to the control unit 21. When the control unit 21 obtains the coordinate data and the frontal direction of the shopping cart 2 from the digital data, the control unit 21 stores the location and the frontal direction of the shopping cart 2 so as to be associated with the position code and the time-stamp data stored in the memory unit 22. With the coordinate data and the frontal direction from the server 1, the current location and the orientation of the shopping cart 2 are attainable. Then, the shopping cart 2 displays the current location and the orientation thereof on the display unit 26. Accordingly, an operator of the shopping cart 2 can reliably grasp the current location and orientation of the shopping cart 2 in the store.

When the shopping cart 2 moves from the place shown in FIG. 3A to the place shown in FIG. 3B, the shopping cart 2 performs communication sequentially with the wireless tags 4a, 4c, and 4e by using the first antenna 32, and sequentially captures position codes of the respective wireless tags 4a, 4c, and 4e. Coordinate data for the position codes are received from the server 1 and stored in the memory unit 22 in an order in which the position codes have been captured, thereby enabling confirmation of a traveled route which the shopping cart 2 has moved. In this way, it is possible for the store to obtain information concerning a traveled route which a customer has moved along with the shopping cart 2. This information can be utilized for sales promotion.

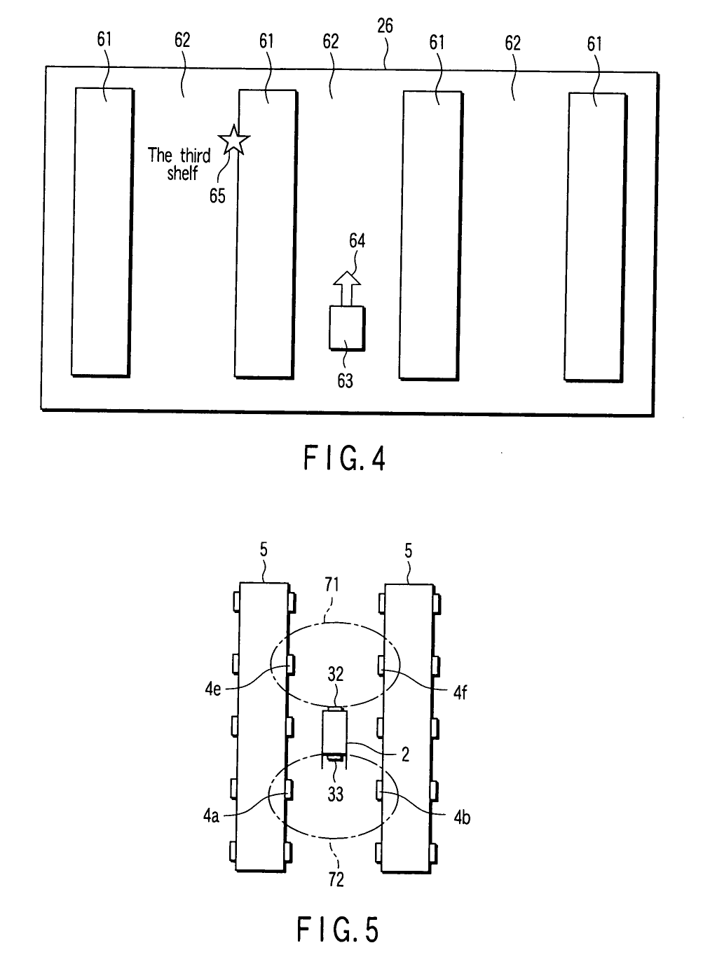

A display example on the display unit 26 is shown in FIG. 4. A map of an aisle 62 defined by the article display racks 5 placed in a layout manner 61 is displayed on the display unit 26. To display the map, the shopping cart 2 requests, in advance, of the server 1 and receives coordinate data of the article display racks 5 held in the database 15, and stores the received coordinate data in the memory unit 22 as information for displaying the map.

Further, the current location 63 of the shopping cart 2 is displayed on the map on the basis of the coordinate data which the shopping cart 2 has received from the server 1 with respect to the position code captured as a result of communication with the wireless tag 4, and an arrow 64 denoting orientation is displayed on the basis of the frontal direction of the shopping cart 2. Note that, if a displayed shape of the shopping cart 2 is a shape by which the frontal direction can be identified, it suffices to display the shopping cart 2 itself in an orientation determined on the basis of the frontal direction even without the arrow 64. Further, the frontal direction of the shopping cart 2 may be fixed so as to always turn up on the screen, and the position and orientation of the aisle 62 defined by the article display racks 5 may be changed on the screen.

There are several methods as a method for confirming the current location 63 of the shopping cart 2. For example, when the shopping cart 2 moves while performing wireless communication sequentially with tags 4a, 4c, and 4e of the wireless tags 4 within a predetermined time, the shopping cart 2 captures a plurality of position codes within the predetermined time. At this time, it is confirmed that the shopping cart 2 is currently located in the vicinity of the wireless tag 4e whose position code has been captured at the last.

Further, in another method, it is confirmed that the shopping cart 2 is currently located in the vicinity of one of the wireless tags 4 whose position code has been captured many times within a predetermined time. For example, assuming that the shopping cart 2 moves while performing wireless communication with the wireless tags 4 in the order of the wireless tags 4a, 4a, 4c, 4c, 4e, and 4c within the predetermined time, the number of times in which communication with the wireless tag 4a has been performed is twice, the number of times in which communication with the wireless tag 4c has been performed three times, and the number of times in which communication with the wireless tag 4e has been performed is once. As a result, because the position code of the wireless tag 4c has been captured most, it is confirmed that the shopping cart 2 is located in the vicinity of the wireless tag 4c.

Further, when there are articles of merchandise which need customer's attention and the store wishes to guide customers to the articles of merchandise, the position coordinates of the articles of merchandise are stored in advance in the database 15, and specific marks 65 are displayed at the position coordinates on the display unit 26 to notify places where the articles of merchandise are displayed. At this time, the article display racks 5 are two-dimensionally displayed as a view from the top. Thus, it is impossible to specify the height of the article of merchandise in the article display rack 5 displayed on the display unit 26. To cope with the problem, a message, for example, of “the third shelf” is displayed along with the mark 65 as height information to inform that the article of merchandise is placed on the third shelf. Instead of the two-dimensional display, the article display racks 5 may be three-dimensionally displayed to show the height of the article of merchandise.

In this way, a person who moves the shopping cart 2 can grasp a positional relationship between the shopping cart 2 and the article of merchandise, and easily approach to the article of merchandise. In addition, when articles of merchandise in promotion are determined as the articles to which customers are guided, this will increase opportunities of the articles of merchandise to be purchased by a customer who moves the shopping cart 2. Accordingly, it is possible to enhance the effect of sales promotion.

Next, in FIG. 3, processing for acquiring a traveling speed given that the horizontal direction is the x-axis, the vertical direction is the y-axis, and the direction perpendicular to the page which is the direction of height of the article display racks 5 is the z-axis, will be described.

When the shopping cart 2 is at the place shown in FIG. 3A, the position coordinates (xᵥ₀, yᵥ₀, zᵥ₀) of the wireless tag 4a and a capture time tᵥ₀ are stored in the memory unit 22. Further, when the shopping cart 2 is at the place shown in FIG. 3B, the position coordinates (xᵥ₁, yᵥ₁, zᵥ₁) of the wireless tag 4c and a capture time tᵥ₁ are stored in the memory unit 22. In this way, the shopping cart 2 sequentially records the position coordinates and the like. Thus, it is possible to confirm a traveled route of the shopping cart 2.

By substitution for the following formula (1) by utilizing the two position coordinates and capture times, it is possible to calculate a traveling speed V of the cart 2.

$$V = \sqrt{{( \frac{{x}_{v 1} - {x}_{v 0}}{{t}_{v 1} - {t}_{v 0}} )}^{2} + {( \frac{{y}_{v 1} - {y}_{v 0}}{{t}_{v 1} - {t}_{v 0}} )}^{2}} \qquad ( 1 )$$

Here, the shopping cart 2 is to move on the horizontal floor, which means that the direction of height does not vary, and therefore, the information on the z-axis is ignored. In this way, it is possible to confirm a traveling speed V of the cart 2.

When the shopping cart 2 is staying at the same place, the same position code is captured many times. At this time, it is necessary to inquire of the server 1 about the position coordinates only at the first time when the position code is captured, and there is no need thereafter to inquire of the server 1 about the position coordinates. Given that a time when a position code of the wireless tag 4a is captured first time is tₐ₀, and a time when the same position code is captured at the last in a case in which a same position code is captured several times is tₐ₁, a time for which the shopping cart 2 has stayed in the vicinity of the wireless tag 4a is found by tₐ₁-tₐ₀. In this way, it is possible to confirm a time length of stay at one place of the shopping cart 2.

Thus far, it has been described a technique of capturing the position codes of the wireless tags 4 with the use of only the first antenna 32 to obtain position coordinates and a frontal direction. However, the two antennas 32 and 33 are present on the shopping cart 2. The position coordinates and the frontal direction are obtainable by capturing with the use of these antennas 32 and 33. A case in which the two antennas are used will be described by using FIGS. 3A and 3B.

First, it is the same as described above that the first antenna 32 is connected to the circulator 30 by the switching unit 31 to capture a position code from the wireless tag 4a, and position coordinates and a frontal direction are obtained as a capture result.

Next, switching by the switching unit 31 is carried out to disconnect the first antenna 32 from the circulator 30 and connect the second antenna 33 to the circulator 30.

In this state, when a radio signal is radiated from the second antenna 33, the wireless tag 4b at the article display rack 5 on the right side starts to operate, and transmits a position code to the shopping cart 2. In the same manner as the position code captured from the wireless tag 4a, the shopping cart 2 transmits the position code captured from the wireless tag 4b to the server 1, and receives position coordinates and a frontal direction corresponding thereto from the server 1. As a result, it is confirmed that the shopping cart 2 is present at a location intermediate between the position coordinates of the wireless tag 4a and the wireless tag 4b. In this way, by using both of the first antenna 32 and the second antenna 33, the current location of the shopping cart 2 can be confirmed with great precision.

When the shopping cart 2 is located at the place shown in FIG. 3B, the shopping cart 2 receives position codes from the wireless tags 4c, 4d, 4e, and 4f within a predetermined time. The shopping cart 2 transmits the captured position codes to the server 1, and receives position coordinates corresponding to the position codes from the server 1. More specifically, the shopping cart 2 receives the position coordinates (x₀, y₀, z₀) of the wireless tag 4c, the position coordinates (x₁, y₁, z₁) of the wireless tag 4d, the position coordinates (x₂, y₂, z₂) of the wireless tag 4e, and the position coordinates (x₃, y₃, z₃) of the wireless tag 4f. Then, it is confirmed that the shopping cart 2 is present at the center of these four coordinates. At this time, coordinates (x, y, z) of the center of these four points can be determined by using the following formula (2).

$$( x , y , z ) = ( \frac{{x}_{0} + {x}_{1} + {x}_{2} + {x}_{3}}{4} , \frac{{y}_{0} + {y}_{1} + {y}_{2} + {y}_{3}}{4} , \frac{{z}_{0} + {z}_{1} + {z}_{2} + {z}_{3}}{4} ) \qquad ( 2 )$$

Given that there are n position codes captured by the shopping cart 2 within a predetermined time, the following formula (3) may be used.

$$( x , y , z ) = ( \frac{{\sum }_{i = 0}^{n - 1} {x}_{i}}{n} , \frac{{\sum }_{i = 0}^{n - 1} {y}_{i}}{n} , \frac{{\sum }_{i = 0}^{n - 1} {z}_{i}}{n} ) \qquad ( 3 )$$

Note that, when the shopping cart 2 moves on the horizontal floor, the height of the cart is not changed, and therefore, there is no need to calculate the z-axis. In this way, the location of the shopping cart 2 can be confirmed more precisely.

Further, the location of the shopping cart 2 may be calculated in consideration of time stamps at which the position codes have been captured. In this case, locations defined by the position coordinates corresponding to the captured position codes are averaged by using weighing factors which are set to be greater as elapse of time, and an average result is determined as the location of the shopping cart 2.

Since there are the two antennas 32 and 33 on the shopping cart 2, it is possible to grasp the current location and orientation of the shopping cart 2 even if the wireless tags 4 are provided to the article display racks 5 on only one of the right and left sides of the aisle. Further, in the present embodiment, the wireless tags 4 are attached to the front portions of the shelves 50 of the article display racks 5. However, the wireless tags 4 may be attached to any portions adjacent to the aisle, such as portions of the ceiling which are present above the article display racks 5. In this case, the first antenna 32 is attached to the left-side surface of the basket 34 of the shopping cart 2 such that the antenna plane faces the ceiling, and the second antenna 33 is attached to the right-side surface of the basket 34 such that the antenna plane faces the ceiling.

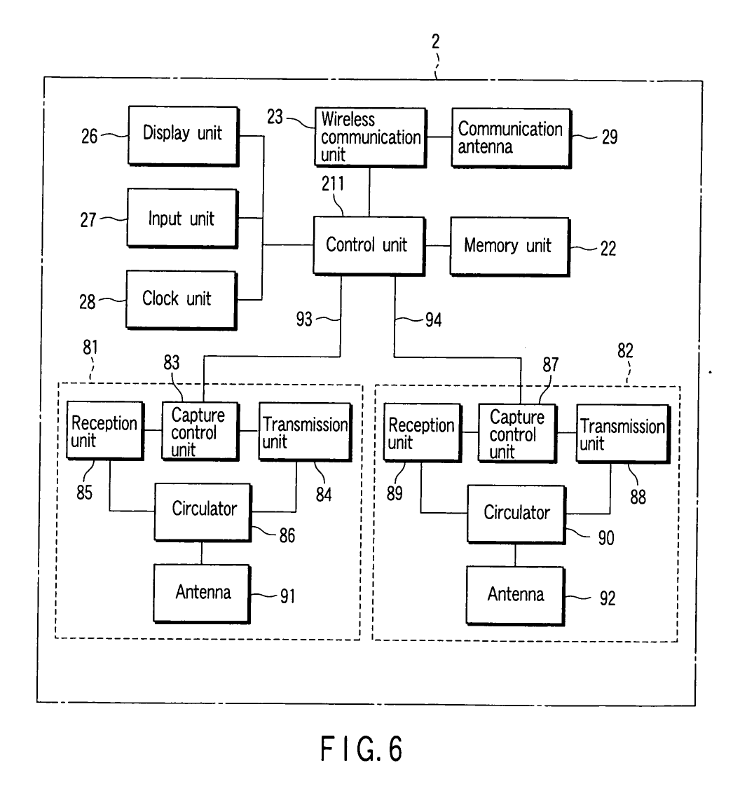

Next, a moving object management system according to a second embodiment of the present invention will be described. Note that components which are the same as those in the first embodiment described above are denoted by the same reference symbols, and detailed descriptions thereof will be omitted. In the first embodiment, the first antenna 32 is provided on the left side of the shopping cart 2, and the second antenna 33 is provided on the right side of the shopping cart 2. However, in the present embodiment, as shown in FIG. 5, the first antenna 32 is provided on the front side of the shopping cart 2, and the second antenna 33 is provided on the rear side of the shopping cart 2. The configuration of the server 1, the shopping cart 2, and the wireless tag 4 is the same as that in the first embodiment.

When the first antenna 32 is made operative, the shopping cart 2 is able to perform wireless communication with the wireless tags 4e and 4f within a communication service area 71. Further, when the second antenna 33 is made operative, the shopping cart 2 is able to perform wireless communication with the wireless tags 4a and 4b within a communication service area 72. The shopping cart 2 sequentially captures the position codes of the wireless tags 4a, 4b, 4e, and 4f, transmits the position codes to the server 1, and receives position coordinates corresponding to the position codes from the server 1.

The shopping cart 2 calculates the center of the position coordinates of the wireless tags 4a, 4b, 4e, and 4f and regard the center as the current location thereof. Further, based on the fact that the position codes of the wireless tags 4e and 4f have been captured using the fist antenna 32, and the position codes of the wireless tags 4a and 4b have been captured using the second antenna 33, it is confirmed that the shopping cart 2 is oriented to the side of the wireless tags 4e and 4f. That is, the wireless tags 4e and 4f are present in the frontal direction of the shopping cart 2. In this way, even when the antennas 32 and 33 are provided on the front side and the rear side, it is possible to grasp the current location and orientation of the shopping cart 2 on the basis of the coordinate data from the server 1 and the antenna position data.

Further, it is possible to grasp the current location and orientation of the shopping cart 2 even if the wireless tags 4 are provided to the article display racks 5 on only one of the right and left sides of the aisle. In the present embodiment, the wireless tags 4 are attached to the front portions of the shelves 50 of the article display racks 5. However, the wireless tags 4 may be attached to any portions adjacent to the aisle, such as portions of the ceiling which are present above the article display racks 5. In this case, the first antenna 32 is attached to the front-side surface of the basket 34 of the shopping cart 2 such that the antenna plane faces the ceiling, and the second antenna 33 is attached to the rear-side surface of the basket 34 such that the antenna plane faces the ceiling.

Next, a moving object management system according to a third embodiment of the present invention will be described. Note that components which are the same as those in the first embodiment described above are denoted by the same reference symbols, and detailed descriptions thereof will be omitted. The configuration of the server 1 and the wireless tag 4 is the same as that in the first embodiment.

In the shopping cart 2, as shown in FIG. 6, the memory unit 22, the wireless communication unit 23, the display unit 26, the input unit 27, and the clock unit 28 are connected to a control unit 211, and a first capturing unit 81 and a second capturing unit 82 are connected to the control unit 211.

In the first capturing unit 81, a transmission unit 84 and a reception unit 85 are connected to a capture control unit 83, and the transmission unit 84 and the reception unit 85 are connected to a circulator 86. Then, a first antenna 91 is connected to the circulator 86. In the second capturing unit 82, a transmission unit 88 and a reception unit 89 are connected to a capture control unit 87, and the transmission unit 88 and the reception unit 89 are connected to a circulator 90. Then, a second antenna 92 is connected to the circulator 90.

The capture control unit 83 controls the transmission unit 84 and the reception unit 85, and carries out data exchange with the control unit 211. The transmission unit 84 operates in the same manner as the transmission unit 24, the reception unit 85 operates in the same manner as the reception unit 25, and the circulator 86 operates in the same manner as the circulator 30. The capture control unit 87 controls the transmission unit 88 and the reception unit 89, and carries out data exchange with the control unit 211. The transmission unit 88 operates in the same manner as the transmission unit 24, the reception unit 89 operates in the same manner as the reception unit 25, and the circulator 90 operates in the same manner as the circulator 30. The control unit 211 controls the first capturing unit 81 and the second capturing unit 82 to operate alternately.

The configuration of the shopping cart 2 is basically the same as that in FIG. 2. However, the first capturing unit 81 is substituted for the first antenna 32 in FIG. 2, and the second capturing unit 82 is substituted for the second antenna 33 in FIG. 2. With this configuration, the control unit 211, the memory unit 22, the wireless communication unit 23, the display unit 26, the input unit 27, the clock unit 28, and the communication antenna 29 are provided in the operation panel section 38, and the capturing units 81 and 82 are connected to the control unit 211 by signal lines 93 and 94. Namely, the signal lines 93 and 94 are ordinary ones applied in place of the coaxial cables 39 and 40. The directivity of the first antenna 91 is the same as the directivity of the first antenna 32, and the directivity of the second antenna 92 is the same as the directivity of the second antenna 33.

With this configuration, a position code of a wireless tag 4 captured by using the first antenna 91 is output from the first capturing unit 81 to the control unit 211, and is transmitted to the server 1 by using the wireless communication unit 23. Then, the server 1 obtains position coordinates corresponding to the position code and a frontal direction of the shopping cart 2 and transmits data of the position coordinates and the frontal direction. The data of the position coordinates and the frontal direction are received by using the wireless communication unit 23, and the control unit 211 stores the data in the memory unit 22. Further, a position code of a wireless tag 4 captured by using the second antenna 92 is output from the second capturing unit 87 to the control unit 211, and is transmitted to the server 1 by using the wireless communication unit 23. Then, the server 1 obtains position coordinates corresponding to the position code and a frontal direction of the shopping cart 2, and transmits data of the position coordinates and the frontal direction. The data of the position coordinates and the frontal direction are received by using the wireless communication unit 23, and the control unit 211 stores the data in the memory unit 22.

In this way as well, it is possible to reliably grasp the current location and the frontal direction, i.e., orientation of the shopping cart 2. Moreover, with this configuration, it suffices for the coaxial cables to be used in an extremely short distance between the antennas 91 and 92, and the circulators 86 and 90, thereby reducing the attenuation amount of a high-frequency signal by the coaxial cables. Therefore, even if transmission power from the transmission units 84 and 88 is set to be lower than that in the first embodiment, it is possible to secure communication service areas which are the same as those in the first embodiment. Namely, it is possible to reduce a power consumption of the shopping cart 2.

Next, a moving object management system according to a fourth embodiment of the present invention will be described. Note that components which are the same as those in the embodiments described above are denoted by the same reference symbols, and detailed descriptions thereof will be omitted. The configuration of the server 1 and the wireless tag 4 are the same as that in the first embodiment.

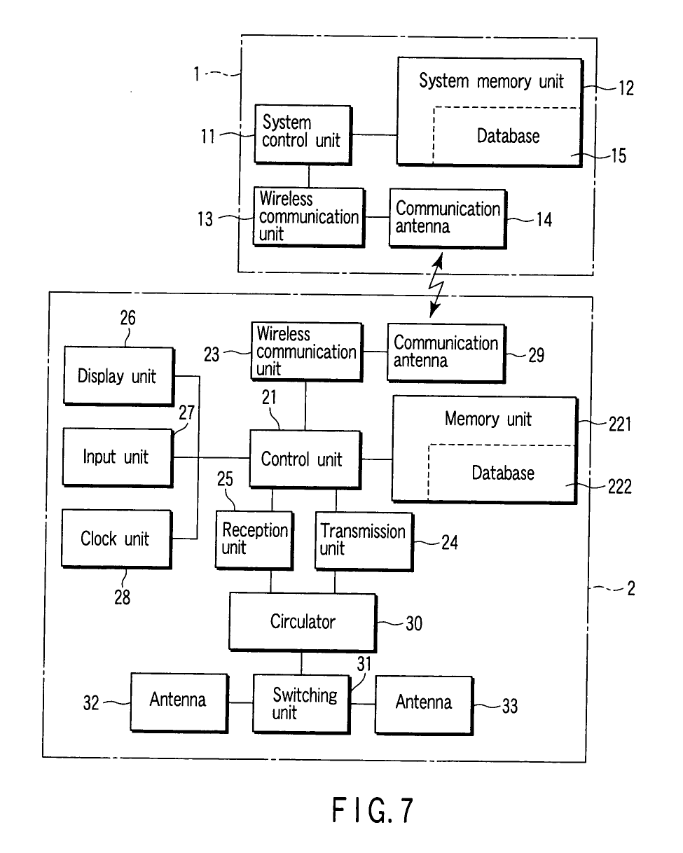

The shopping cart 2 is configured as shown in FIG. 7. The control unit 21 is connected to a memory unit 221 which includes a flash memory in addition to the ROM, and the RAM. In the flash memory, a database 222 is provided. Other structures are the same as those in the first embodiment.

The database 222 has the same contents as those in the database 15 of the server 1. When the database 15 is updated in the server 1, the system control unit 11 transmits the updated information to the shopping cart 2 by using the wireless communication unit 13 and the communication antenna 14. The shopping cart 2 receives the updated information from the server 1 by using the communication antenna 29 and the wireless communication unit 23, and the control unit 21 stores the information in the flash memory to update the contents of the database 222. In this way, the contents of the database 222 are maintained to be identical to those in the data base 15.

With this configuration, the shopping cart 2 captures a position code of a wireless tag 4 at the reception unit 25 by using the first antenna 32. The position code is send from the reception unit 25 to the control unit 21. The control unit 21 acquires position coordinates corresponding to the position code with reference to the database 222 in the memory unit 221. Then, the control unit 21 determines the current location and the frontal direction, i.e., a direction of the shopping cart 2 based on the position coordinates and the position of the first antenna 32 which has been used for capturing the position code.

In this way, the shopping cart 2 confirms the current location and the frontal direction thereof without performing communication with the server 1. Accordingly, it is possible to more rapidly report the location and the frontal direction of the shopping cart 2 by being displayed on the display unit 26. Further, since the number of times in which wireless communication is performed between the shopping cart 2 and the server 1 is reduced, it is possible to reduce a power consumption of the shopping cart 2.

In each embodiment described above, the shopping cart 2 in a store has been used as a moving object apparatus, and confirmation of the current location and the orientation of the shopping cart 2, and additionally, confirmation of the traveled route, confirmation of the traveling speed, the time length of stay, or the like have been described. However, the present invention is not limited thereto, and is applicable to a system using a warehouse forklift truck, a book carrier cart in a library, or the like, as a moving object apparatus.

With respect to a warehouse forklift truck, for example, articles to be shipped can be substituted for the articles to which customers are guided. On the forklift truck, the current location and the orientation thereof are displayed together with places where the articles to be shipped are present. In accordance therewith, it is possible to shorten a time to search the articles. Further, with respect to a book carrier cart in a library, shelf-slots for receiving returned books can be substituted for the articles to which customers are guided. On the book carrier cart, the current location and the orientation thereof are displayed together with places where the shelf-slots are present. In accordance therewith, it is possible to shorten a time to search the shelf-slots.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving object apparatus comprising:
a moving object to be moved along an aisle which is provided together with a plurality of wireless tags arranged near said aisle;
an antenna unit which is mounted on said moving object and has directivity toward a direction predetermined for communication with said wireless tags;
capturing means for capturing positional identification data held by each of said wireless tags which are accessible by said antenna unit; and
processing means for processing a capture result of said capturing means based on antenna position data of said antenna unit which has been used for capturing the positional identification data.

2. The moving object apparatus according to claim 1, wherein said processing means is configured to specify a location of said moving object based on the positional identification data which is the capture result, and to specify an orientation of said moving object based on the positional identification data and the antenna position data.

3. The moving object apparatus according to claim 2, wherein said processing means is configured to further specify a traveled route of said moving object based on a change in the positional identification data which is the capture result.

4. The moving object apparatus according to claim 2, wherein said processing means is configured to further obtain a time for which the positional identification data is repeatedly captured after the location of said moving object has been specified based on the positional identification data, as a time length of stay at the location of said moving object.

5. The moving object apparatus according to claim 2, wherein said processing means includes display means for displaying the location and the orientation of said moving object.

6. The moving object apparatus according to claim 2, wherein said processing means includes display means for displaying a map of the aisle showing a place where said moving object is guided, along with the location and the orientation of said moving object.

7. The moving object apparatus according to claim 2, wherein said processing means is configured to receive position coordinates of the wireless tag corresponding to positional identification data from an external server to specify the location and the orientation of said moving object.

8. The moving object apparatus according to claim 2, wherein said processing means includes a database holding position coordinates of said wireless tags to be associated with the positional identification data held by said wireless tags.

9. The moving object apparatus according to claim 1, wherein said antenna unit includes a first antenna having directivity toward left of said moving object and a second antenna having directivity toward right of said moving object, and the antenna position data represents one of the first and second antennas which has been used for capturing the positional identification data.

10. The moving object apparatus according to claim 1, wherein said antenna unit includes a first antenna which is mounted on a front portion of said moving object and has directivity toward at least one of right and left of said moving object, and a second antenna which is mounted on a rear portion of said moving object and has directivity toward at least one of right and left of said moving object, and the antenna position data represents one of said first and second antennas which has been used for capturing the positional identification data.

11. The moving object apparatus according to claim 1, wherein said capturing means includes a transmission unit which performs transmission to said wireless tags, a reception unit which performs reception from said wireless tags, and a circulator which causes said transmission unit and said reception unit to be commonly connected to said antenna unit.

12. A moving object apparatus comprising:
a moving object to be moved along an aisle which is provided together with a plurality of wireless tags arranged near the aisle;
an antenna unit which is mounted on said moving object and has directivity toward a direction predetermined for communication with said wireless tags;
a control panel section which captures positional identification data held by each of said wireless tags which are accessible by said antenna unit, and processes a capture result based on antenna position data of said antenna unit which has been used for capturing the positional identification data.
